(19) United States
(12) Patent Application Publication
(10) Pub. No.: US 2010/0295286 A1
(43) Pub. Date: Nov. 25, 2010

(54) Cover and method of manufacturing the same

(76) Inventors: Keith E. Goldstein, Framingham, MA (US); Erik Mitterhofer, Dedham, MA (US)

Correspondence Address: KRIEGSMAN & KRIEGSMAN, 30 TURNPIKE ROAD, SUITE 9, SOUTHBOROUGH, MA, 01772, US

(21) Appl. No.: 12/800,474

(22) Filed: May 13, 2010

Related U.S. Application Data
(60) Provisional application No. 61/216,110, filed on May 13, 2009.

(51) Int. Cl. B42D 3/02; B29C 44/06

(52) U.S. Cl. 281/29; 156/78

(57) ABSTRACT

An electronic cover for a passport, booklet or the like includes an electronic device and a layer of cover material that are bonded together by a fill-up adhesive layer, the electronic device preferably being in the form of an RFID inlay that includes a substrate, an antenna coupled to the substrate and an integrated circuit (IC) chip module conductively coupled to the antenna. During manufacture of the cover, the fill-up adhesive layer is applied to at least one of the electronic device and the layer of cover material. Immediately thereafter, the electronic device and the layer of cover material are held spaced apart from one another a predefined distance so as to define a void therebetween. Through a suitable trigger, the fill-up adhesive layer expands to fill in the entire void and subsequently cures to bond the electronic device to the layer of cover material.

### CROSS-REFERENCE TO RELATED APPLICATIONS

The present application claims the benefit under 35 U.S.C. 119(e) of U.S. provisional patent application Ser. No. 61/216,110, filed May 13, 2009, the disclosure of which is incorporated herein by reference.

### BACKGROUND OF THE INVENTION

The present invention relates generally to covers for passports, booklets and the like and, more specifically, to covers that are enhanced with radio frequency identification (RFID) capabilities.

A passport is a document, issued by a national government, which certifies, for the purpose of international travel, the identity and nationality of its owner. A conventional passport includes a multi-paged insert, or booklet, that is bound to a protective outer cover. As can be appreciated, the multi-paged booklet typically includes both (i) an identification page, or datapage, that displays pertinent identification information relating to the owner of the passport and (ii) a plurality of visa pages that are used to document specific dates of entry and exit into particular countries.

The International Civil Aviation Organization (ICAO) currently regulates passport standards for nearly 190 member states. At the present time, the ICAO requires that all new passports be manufactured with the capability to store and transmit electronic data as a further means of owner authentication, these types of passports being commonly referred to as electronic passports in the art. The data stored on an electronic passport may include, inter alia, various types of biometric information, such as fingerprints, retinal scans, and voice samples.

Accordingly, referring now to FIG. 1, there is shown an electronic passport 11 that is well-known in the art. As can be seen, electronic passport 11 includes a multi-paged booklet 13 that is permanently bound to a protective outer cover 15. As will be described in detail below, outer cover 15 of electronic passport 11 includes a radio frequency identification (RFID) inlay, or pre-lam, 17 (i.e., an RFID device with one or more lamination layers) that is affixed to a layer of cover material 19 by an adhesive.

Referring now to FIGS. 2(a)-(i), there is shown a series of section views that is useful in illustrating one well-known method of manufacturing cover 15. Specifically, in the first step of the cover manufacturing process, a substrate 21 is gathered, as shown in FIG. 2(a). Substrate 21 is typically formed from an enlarged of sheet of suitable plastic material (e.g., a microporous silica-filled polyolefin, such as a TESLIN® microporous material) and includes a flat top surface 21-1 and a flat bottom surface 21-2. In turn, substrate 21 is punched to define a vertical hole, or window, 23, as shown in FIG. 2(b). Although not shown herein, a thin plastic seal may be fused to substrate 21 to hermetically enclose window 23 along bottom surface 21-2 and thereby protect sensitive electrical components and connections in pre-lam 17 from potentially harmful environmental elements, such as moisture.

In the next step of the manufacturing process, a conductive antenna 25 is applied to top surface 21-1 of substrate 21 by any suitable means, such as through the use of embedding, etching, plating, printing or the like. Preferably, antenna 25 is arranged in a coiled, or spiraled, configuration around hole 23 to enhance signal transmission. As shown in FIG. 2(d), an integrated circuit (IC) chip module 27 is then coupled to antenna 25 (e.g., through soldering), the resultant product being referred to herein as RFID inlay, or core inlay, 29. It should be noted that IC chip module 27 comprises an IC chip 31 that is conductively mounted onto a lead frame 33, IC chip 31 being encapsulated within a mold compound, or IC package, 35 for protection. As can be seen, IC chip module 27 is coupled to antenna 25 with IC chip 31 facing downward (i.e., chip-side down) such that IC package 35 projects into window 23 and lead frame 33 lies in conductive contact against antenna 25.

Due to the relatively uneven top profile of resultant core inlay 29, one or more compensation layers are laminated thereto. In the present example, a compensation layer 37 in the form of an enlarged plastic sheet is gathered, as shown in FIG. 2(e), punched to define a hole 39, as shown in FIG. 2(f), and in turn aligned on top of RFID inlay 29 so that lead frame 33 fittingly aligns within hole 39, as shown in FIG. 2(g).

Compensation layer 37 is then laminated to substrate 21 (e.g., by fusing, melting and/or welding said layers) to form substantially flat, unitary RFID pre-lam 17, as shown in FIG. 2(h). An adhesive 41 is then applied to the exposed top surface of pre-lam 17, as shown in FIG. 2(i). In turn, a layer of cover material 19 constructed from an aesthetically and functionally optimal material, such as cloth, synthetic cloth, cotton or composites thereof, is then rolled into contact against adhesive 41 to yield the finished cover 15, as shown in FIG. 2(j).

To minimize manufacturing costs, it should be noted that multiple electronic passports are often produced from a single-sheet supply of the finished cover (e.g., two standard passports being produced from a 2-up sized cover sheet, three standard passports being produced from a 3-up sized cover sheet, etc.). In this situation, a single, enlarged multi-page booklet is bound to the underside of the enlarged cover. In a subsequent step, the resultant product is stamped or otherwise cut to yield the plurality of individual electronic passports. Although not described in detail herein, it is to be understood that the exposed top surface of each passport cover may be marked with notable indicia by any suitable means (e.g., through a hot foil stamping process).

As can be appreciated, the aforementioned process for constructing a cover for an electronic passport suffers from a few notable drawbacks.

As a first drawback, the adhesive layer applied to the top surface of the RFID pre-lam does not act as a hermetic seal. As a result, relatively sensitive electronic connections, such as the connection between the IC chip module and the antenna, are exposed to potentially harmful environmental conditions, such as moisture.

As a second drawback, layers that are affixed to the RFID inlay (e.g., compensation layers, cover material, etc.) are traditionally applied using considerable amounts of heat and/or pressure which, in turn, can damage the IC chip module and/or connections thereto.

As a third drawback, the above-described process requires a relatively large quantity of parts and the execution of many complex steps, thereby substantially increasing overall manufacturing costs.

As a fourth drawback, the structural integrity of the cover is often limited by the strength of the lamination. In particular, it has been found that, over time, the lamination layers are susceptible to separation, thereby compromising the durability of the cover.

### SUMMARY OF THE INVENTION

It is an object of the present invention to provide a new and improved cover for an electronic passport and method of manufacturing the same.

It is another object of the present invention to provide a new and improved cover of the type described above that has a limited number of parts and is cost-effective to manufacture.

It is yet another object of the present invention to provide a cover of the type as described above that renders sensitive electrical components and connections established thereto less susceptible to potentially harmful environmental conditions.

It is still another object of the present invention to provide a cover of the type as described above that is of a high structural integrity.

It is yet still another object of the present invention to provide a cover of the type as described above that is manufactured using limited applications of heat and pressure.

Accordingly, as one feature of the present invention, there is provided a cover for a passport, booklet or the like, the cover comprising (a) an electronic device, (b) a layer of cover material spaced apart from the electronic device, and (c) a fill-up adhesive layer disposed between the electronic device and the layer of cover material, the fill-up adhesive layer being bonded directly to each of the electronic device and the layer of cover material.

As another feature of the present invention, there is provided a method of manufacturing a cover for a passport, booklet or the like, the method comprising the steps of (a) providing an electronic device, (b) providing a layer of cover material, (c) applying a fill-up adhesive layer onto at least one of the electronic device and the layer of cover material, (d) holding the layer of cover material and the electronic device apart from one another so as to define a void therebetween, (e) expanding the fill-up adhesive layer to fill in the entire void between the electronic device and the layer of cover material, and (f) curing the fill-up adhesive layer to bond the electronic device to the layer of cover material.

Additional objects, as well as features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate an embodiment of the invention and, together with the description, serve to explain the principles of the invention. In the drawings, wherein like reference numerals represent like parts:

FIG. 1 is a front perspective view of an electronic passport which is well known in the art, the cover material being partially folded back onto itself in order to show details of the radio frequency identification (RFID) inlay;

FIGS. 2(a)-(j) are a series of section views that is useful in illustrating one well-known method of manufacturing the cover for the electronic passport shown in FIG. 1;

FIG. 3(a) is a front perspective view, broken away in part, of a first embodiment of a cover for an electronic passport, the cover being constructed according to the teachings of the present invention;

FIG. 3(b) is a simplified section view of the cover shown in FIG. 3(a), taken along lines 3b-3b;

FIG. 4 is a detailed front plan view, broken away in part, of the RFID inlay shown in FIG. 3(b);

FIGS. 5(a)-(d) are a series of front plan views that is useful in illustrating one method of manufacturing the cover shown in FIG. 3(b);

FIG. 6 is a front plan view of a second embodiment of a cover for an electronic passport constructed according to the teachings of the present invention; and

FIG. 7 is a section view of a third embodiment of a cover for an electronic passport constructed according to the teachings of the present invention.

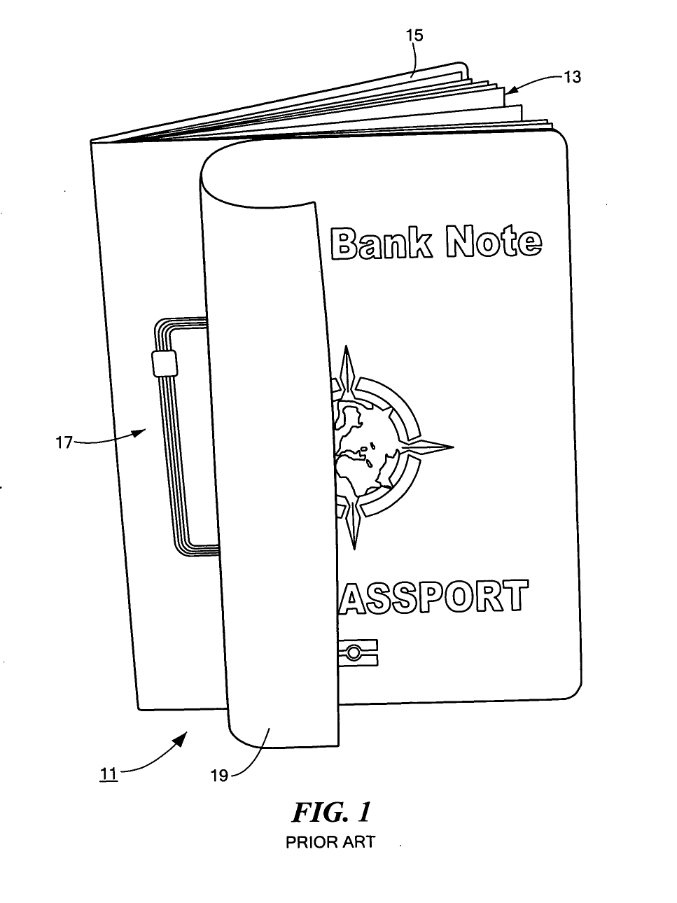

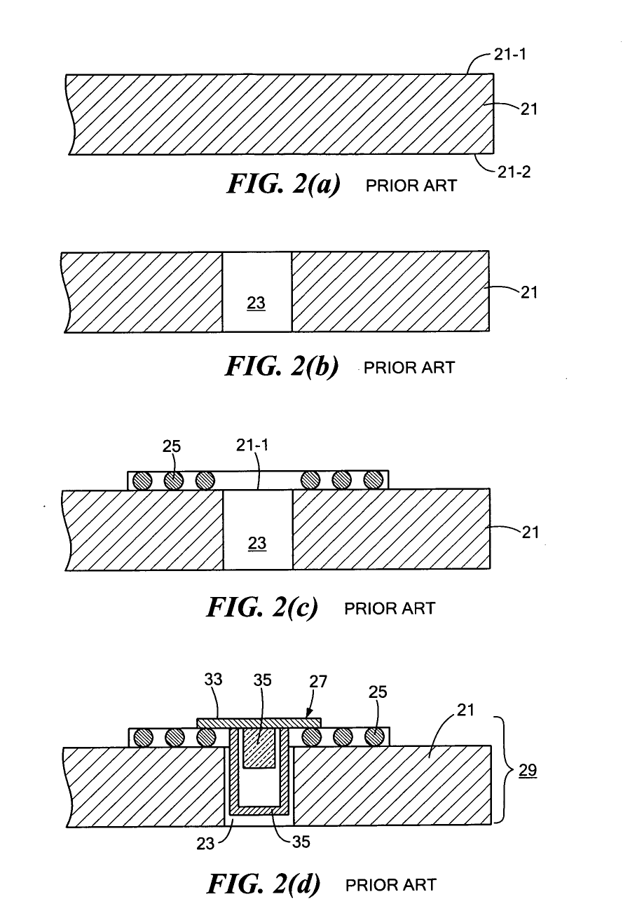

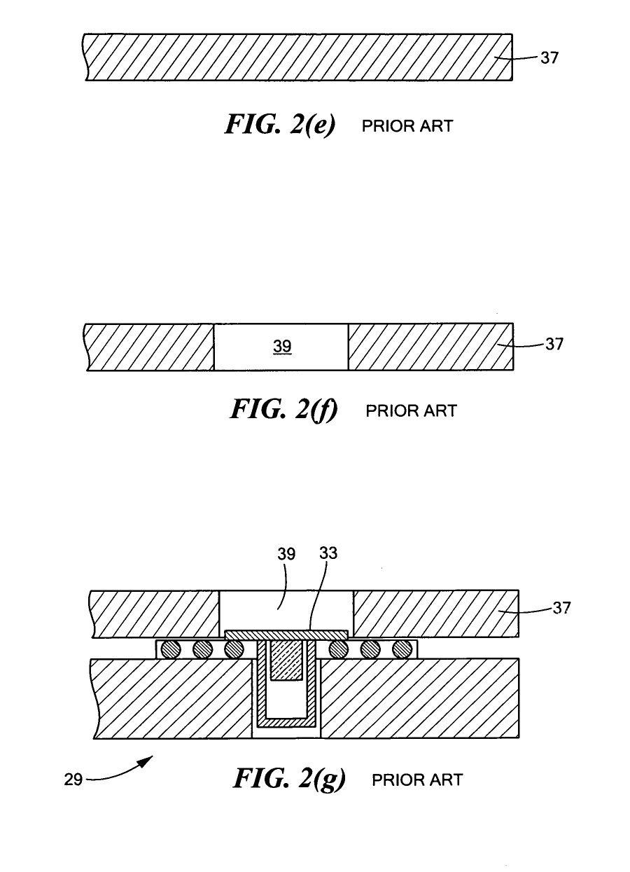

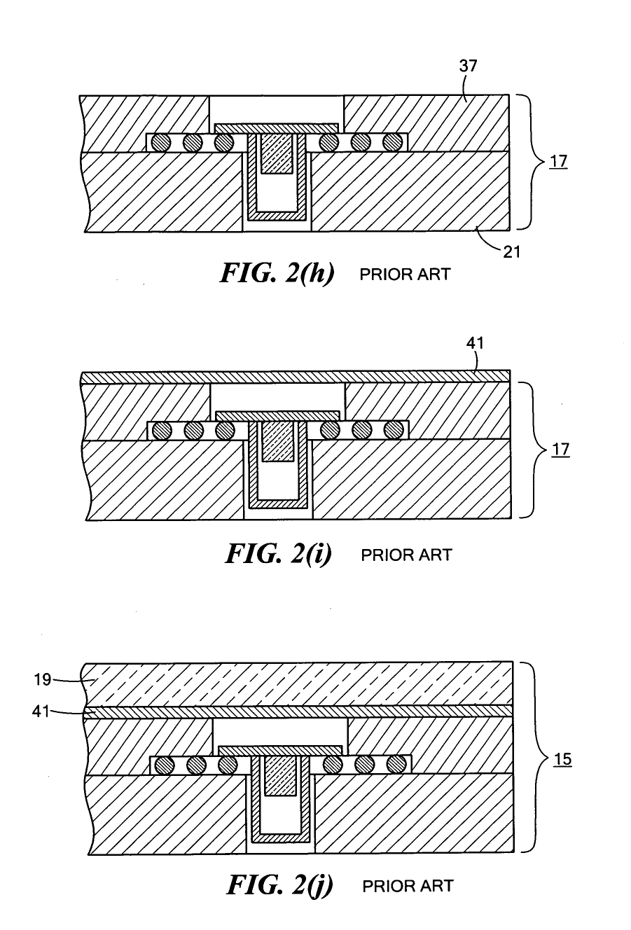

### DETAILED DESCRIPTION OF PREFERRED EMBODIMENTS

### Cover 111 for an Electronic Passport

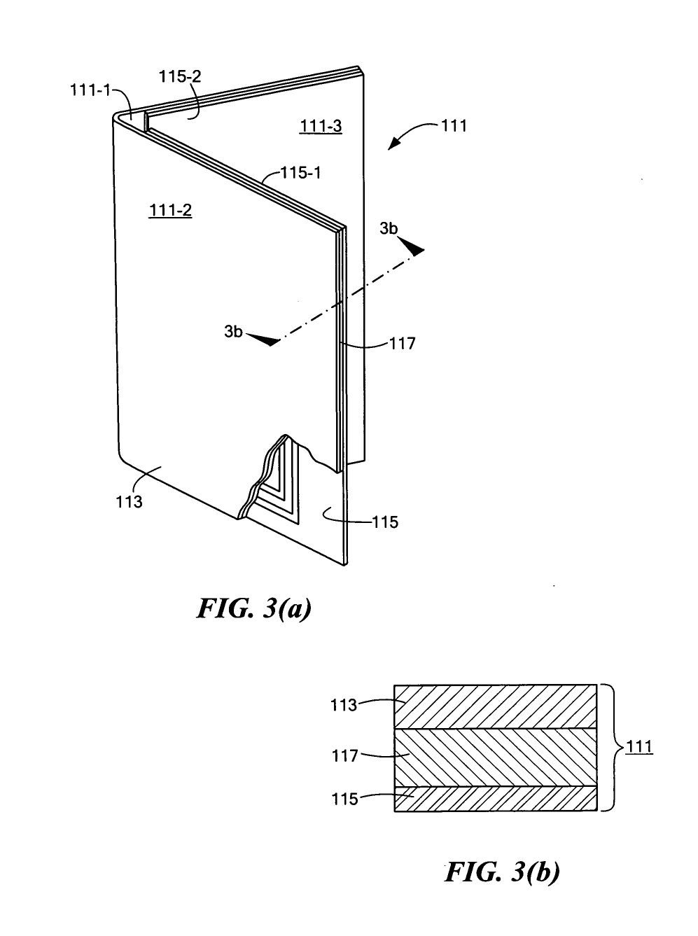

Referring now to FIGS. 3(a) and 3(b), there are shown front perspective and section views of a first embodiment of a cover for an electronic passport, the cover being constructed according to the teachings of the present invention and identified generally by reference numeral 111. As will be described further below, cover 111 is capable of storing and transmitting electronic data. For this reason, cover 111 is also referred to herein as electronic cover, or eCover, 111.

For purposes of simplicity only, cover 111 is described herein for use as an outer protective cover for an electronic passport. However, it should be noted that cover 111 is not limited to use in connection with electronic passports. Rather, it is to be understood that cover 111 could be used in a similar capacity for alternative types of security-enhanced booklets, such as bank booklets, without departing from the spirit of the present invention.

As can be seen, cover 111 comprises a layer of cover material 113 that is secured to an electronic device 115 using a fill-up adhesive layer 117. As a notable step in the manufacturing process for cover 111, fill-up adhesive layer 117 is applied to at least one of cover material 113 and electronic device 115. As will be described further in detail below, cover material 113 and electronic device 115 are then spaced apart from one another a predefined distance. Through an appropriate trigger, fill-up adhesive layer 117 expands, filling in the void between cover material 113 and electronic device 115, and then cures so as to permanently secure cover material 113 to electronic device 115. In this capacity, fill-up adhesive layer 117 not only secures cover material 113 to electronic device 115 without any significant application of heat or pressure to electronic device 115 but also encapsulates certain sensitive electrical components and connections provided in electronic device 115. Consequently, it is to be understood that the use of fill-up adhesive layer 117 to secure cover 113 to electronic device 115 serves as a principal novel feature of the present invention.

Cover material 113 represents any aesthetically and functionally suitable cover material, such as cloth, synthetic cloth, cotton or composites thereof. In the present example, cover 111 is designed for use in an electronic passport application. Accordingly, cover material 113 preferably has a thickness in the range of approximately 300-350 μm and is constructed of a material with visual and textural characteristics in compliance with ICAO standards.

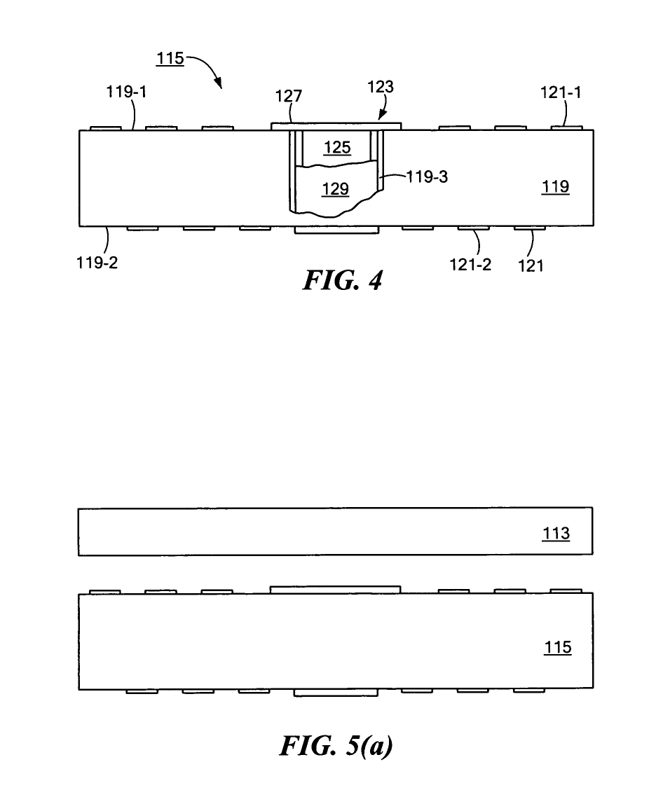

Referring now to FIG. 4, there is shown a detailed front plan view, broken away in part, of electronic device 115. In the present example, electronic device 115 is represented as being in the form of an RFID inlay. However, it should be noted that electronic device 115 is not limited to an RFID inlay construction. Rather, it is to be understood that electronic device 115 could be in the form of any device that is readily capable of storing and transmitting electronic data without departing from the spirit of the present invention.

As can be seen, electronic device 115 comprises a substrate 119, an antenna 121 applied to substrate 119 and an IC chip module 123 conductively coupled to antenna 121 to form a unitary product. Preferably, antenna 121 is applied to substrate 119 using the SECOBO™ antennae deposition process commercialized by Leonard Kurz Stiftung & Co. KG of Germany.

Specifically, electronic device 115 includes a notably thin substrate 119 (approximately 2 mil) that is constructed of a suitable plastic material, such as polyethylene terepthalate (PET). As can be seen, electronic device 115 includes a substantially flat top surface 119-1 and a substantially flat bottom surface 119-2. In addition, a central opening, or hole, 119-3 is vertically punched through substrate 119.

Antenna 121 is constructed of a conductive material, such as copper, and includes a first portion 121-1 electroplated on top surface 119-1 of substrate 119, a second portion 121-2 electroplated on bottom surface 119-2 of substrate 119 and a plurality of plated thru-holes (not shown) punched vertically through substrate 119, each thru-hole connecting segments of first and second portions 121-1 and 121-2 to one another and to IC chip module 123.

IC chip module 123 is conductively coupled to antenna 121 by any conventional means, such as soldering, to yield electronic device 115. IC chip module 123 comprises an IC chip 125 that is conductively mounted onto a lead frame 127, IC chip 125 being encapsulated within a mold compound, or IC package, 129 for protection. As can be seen, IC chip module 123 is coupled to antenna 121 with IC chip 125 facing downward (i.e., chip-side down) such that IC package 129 fittingly protrudes into and partially through hole 119-3 in substrate 119, with lead frame 127 disposed in connection with antenna 121.

It should be noted that the above-described dual-sided antennae deposition process enables antenna 121 to achieve a coiled configuration that is in turn connected to IC chip module 123 without significantly increasing the overall thickness of electronic device 115, which is highly desirable. The reduced thickness of electronic device 115 is achieved, inter alia, by eliminating the requirement that a portion of antenna 121 cross under/over lead frame 127 of IC module 123. As a result, it is to be understood that electronic device 115 has a overall thickness (approximately 3 mil) which is considerably less than most traditional RFID inlays (approximately 10 mil). As can be appreciated, this significant reduction in the thickness of electronic device 115 allows for the use of fill-up adhesive layer 117 without increasing the overall thickness of cover 111 beyond its specified range for electronic passport applications (approximately 700 μm), which is highly desirable.

As noted above, cover 111 is not limited to the use of any particular construction of electronic device 115. For example, it is to be understood that cover 111 could be produced using an electronic device constructed in the form of alternative types of RFID inlays (e.g., RFID inlays of different constructions and thicknesses) without departing from the spirit of the present invention. In particular, it is to be understood that cover 111 could be alternatively manufactured using an RFID inlay that is constructed in a chip-side up configuration without departing from the spirit of the present invention.

Fill-up adhesive layer 117 is preferably in the form of a polyurethane foam that is manufactured and sold by Bayer MaterialScience LLC of Pittsburgh, Pa. under its Baypreg® line of polyurethane materials. Specifically, fill-up adhesive layer 117 is constructed from the reaction product of at least one isocyanate, at least one isocyanate-reactive component and water, optionally in the presence of at least one of blowing agents, surfactants, cross-linking agents, extending agents, pigments, flame retardants, catalysts and fillers, wherein the elastomeric polyurethane foam has a free rise density of from 5 lb/ft³ to 25 lb/f³, a reactive cream time of from 10 seconds to 120 seconds, and an elongation of from 30% to 300%. For additional reference, fill-up adhesive layer 117 may be of the type as described in co-pending U.S. patent application Ser. No. 12/433,043, filed on Apr. 30, 2009, which is incorporated herein by reference.

However, it should be noted that cover 111 is not limited to the use of any particular type of fill-up adhesive layer. Rather, it is to be understood that, as defined herein, fill-up adhesive layer 117 represents any adhesive material, constructed as a foam or otherwise, that is designed to expand into direct contact against and subsequently adhere at least two spaced apart layers, the material filling in the entire void defined between said spaced apart layers. Accordingly, alternative adhesive materials could be used to secure cover material 113 to electronic device 115 without departing from the spirit of the present invention.

Referring back to FIG. 3(a), cover 111 is preferably constructed from a unitary, substantially flat member that includes an electronic device 115 formed preferably as an unitary inlay with a vertically-oriented rectangular opening formed therein. As such, it is to be understood that when the unitary sheet is cut during a final step in the process of manufacturing cover 111, a pair of separate device portions 115-1 and 115-2 is created, with the electronics being provided in one of said device portions 115-1 and 115-2. For example, in cover 111, the electronics are shown as being provided in front device portion 115-1.

It should be noted that the opening in the unitary inlay construction electronic device 115 along the center of cover material 113 creates a narrow, vertically disposed spine 111-1. As can be appreciated, spine 111-1 serves as a fold line about which front cover portion 111-2 is able to pivot relative to rear cover portion 111-3.

To create an electronic passport using cover 111, a layer of adhesive material is preferably applied to the exposed bottom surfaces of front and rear portions 115-1 and 115-2 (i.e., the inner surfaces of front and rear cover portions 111-2 and 111-3). In turn, the front and rear pages of a multi-paged booklet (e.g., of a type similar to booklet 13) are disposed in contact against the layer of adhesive material to yield the finished electronic passport.

### Method of Manufacturing Cover 111

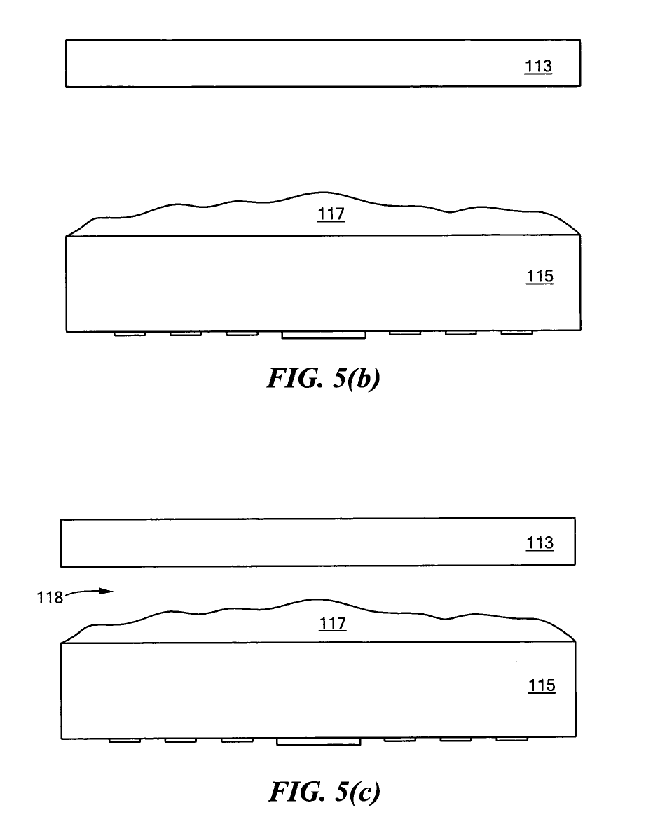

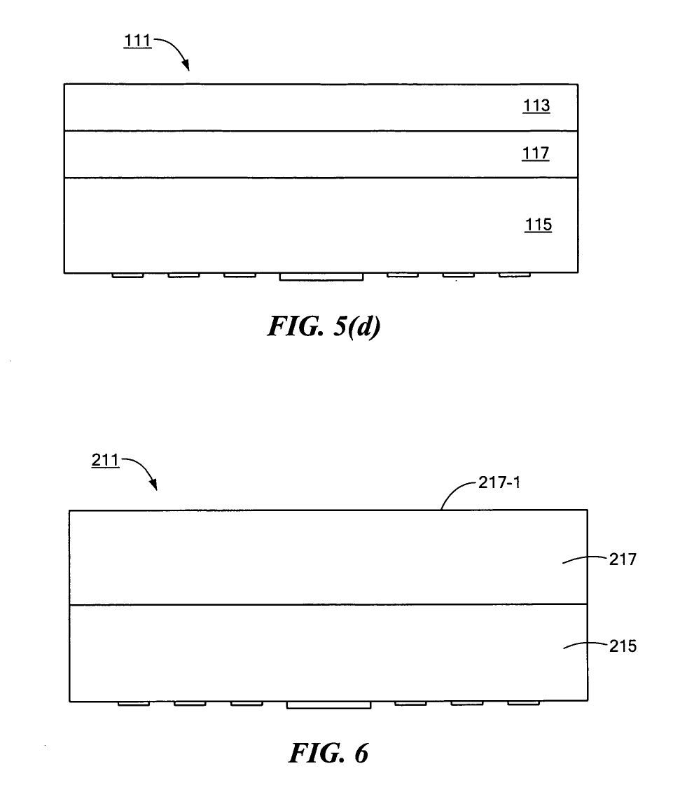

Referring now to FIGS. 5(a)-(d), there is shown a series of front plan views that illustrate a preferred method of manufacturing electronic cover 111. In the first step of the process, both a supply of cover material 113 and electronic device 115 are gathered and held apart from one another, as shown in FIG. 5(a). Next, fill-up adhesive layer 117 is applied onto the inner surface of at least one of cover material 113 and electronic device 115 by any suitable, pressure-sensitive means, such as spray, as shown in FIG. 5(b), fill-up adhesive layer 117 being shown applied to the top profile of electronic device 115 in the present example. Immediately thereafter, the supply of cover material 113 and electronic device 115 are held fixed in place a predefined distance apart from one another so as to define a void 118 therebetween, as shown in FIG. 5(c). In the present example, electronic device 115 is held fixed in place after receiving the application of fill-up adhesive layer 117 and, in turn, cover material 113 is moved into position a predefined distance away from the top profile of electronic device 115.

Using any suitable trigger (e.g., temperature, time or pressure), fill-up adhesive layer 117 expands so as to fill in the entirety of the void 118 defined between cover material 113 and electronic device 115. Shortly thereafter, fill-up adhesive layer 117 cures so as to permanently secure cover material 113 to electronic device 115. The finished product is then cut or stamped to form electronic cover 111, as shown in FIG. 5(d).

As can be appreciated, the aforementioned process is both simple and cost-effective in nature. Furthermore, it should be noted that the expansive characteristics of fill-up adhesive layer 117 not only serves to secure cover material 113 to electronic device 115 without any significant application of heat or pressure to electronic device 115 but also serves encapsulate certain sensitive electrical components and connections provided in electronic device 115, which is highly desirable.

### Alternate Cover Embodiments

It should be noted that cover 111 is not limited to the particular construction and method of manufacture set forth in detail above. Rather, it is to be understood that numerous modifications to the construction of cover 111, as well as its method of preferred manufacture, could be made without departing from the spirit of the present invention.

As an example, it should be noted that electronic cover 111 is not limited to securing cover material 113 to the top profile of electronic device 115. Rather, it is to be understood that cover material 113 could be alternatively secured to the bottom profile of electronic device 115 without departing from the spirit of the present invention. In this circumstance, a multi-paged booklet would then be bound to the top profile of electronic device 115 to yield an electronic passport.

As another example, referring now to FIG. 6, there is shown a second embodiment of a cover for an electronic passport, the cover being constructed according to the teachings of the present invention and identified generally by reference numeral 211. Cover 211 is similar to cover 111 in that cover 211 comprises an electronic device 215 on which a fill-up adhesive layer 217 is secured.

Cover 211 differs from cover 111 in that cover 211 does not include a layer of cover material 113. Rather, it is to be understood that, in place of the layer of cover material 113, the exposed surface 217-1 of fill-up adhesive layer 217 (i.e., the top surface in the present example) is colored and/or textured to closely resemble the appearance of a traditional cover material (e.g., cover material 113). As can be appreciated, the application of aesthetic characteristics to the exposed surface of fill-up adhesive layer 217 can be readily achieved during the adhesive expansion and curing process (e.g., using a textured mold and appropriately colored dyes).

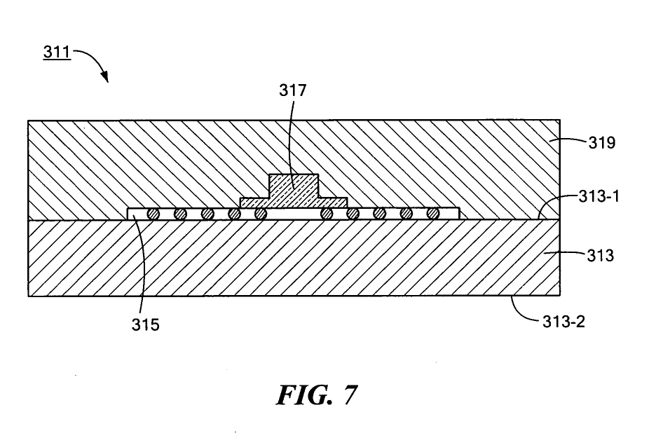

As yet example, referring now to FIG. 7, there is shown a third embodiment of a cover for an electronic passport, the cover being constructed according to the teachings of the present invention and identified generally by reference numeral 311.

Cover 311 differs from cover 111 in that cover 311 does not include a unitary, or modular, electronic device (e.g., RFID inlay). Rather, as can be seen, cover 311 comprises a layer of cover material 313 having a top surface 313-1 and a bottom surface 313-2. An antenna 315 is then directly applied to top surface 313-1 of cover material 313. In turn, an IC chip module 317 is conductively coupled to antenna 315. As such, it is to be understood that together antenna 315 and IC chip module 317 function as an electronic device that is capable of storing and transmitting electronic data.

To protect antenna 315 and IC chip module 317, a fill-up adhesive layer 319 is applied to the top profile of the resultant product (namely, exposed top surfaces of cover material 313, antenna 315 and IC chip module 317). Once fill-up adhesive layer 319 expands and cures, a unitary electronic cover 311 is formed.

As still another example, it should be noted that cover 111 may be modified to additionally include a shielding and/or anti-skimming material for enhanced security purposes. Specifically, it has been found that the owner of electronic passports are often unknowingly susceptible to the theft of stored information by unscrupulous individuals who come in close proximity to the RFID device with an RFID reader. Accordingly, it is to be understood that a shielding material may be integrated into electronic cover 111 in order to limit retrieval of sensitive personal information from the RFID device to when cover 111 is disposed in its open position. By comparison, when cover 111 is retained in its closed position (e.g., when stored in a pocket, pocketbook or the like), stored information would be incapable of retrieval by unscrupulous individuals.

To provide electronic cover 111 with shield protection capabilities, a shielding device is preferably integrated into one of front and rear portions 115-1 and 115-2, the RFID device being preferably integrated into the other of front and rear portions 115-1 and 115-2. Preferably, the shielding device is constructed as a conductive mesh that is plated on substrate 119, the mesh including a detuning antenna that selectively increases the resonance frequency of the RFID device beyond its functional communication range when disposed in close proximity thereto.

Consequently, when the resultant cover is stored in its closed position, the proximity of the shielding device relative to the RFID device effectively precludes retrieval of data from the RFID device. To the contrary, when the cover is opened (e.g., during authorized examination by national customs officials), the shielding device is spaced adequately apart from the RFID device, thereby allowing for the normal transmission of information stored therein.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A cover for a passport, booklet or the like, the cover comprising:
(a) an electronic device,
(b) a layer of cover material spaced apart from the electronic device, and
(c) a fill-up adhesive layer disposed between the electronic device and the layer of cover material, the fill-up adhesive layer being bonded directly to each of the electronic device and the layer of cover material.

2. The cover as claimed in claim 1 wherein the fill-up adhesive layer is in the form of a polyurethane foam.

3. The cover as claimed in claim 2 wherein the polyurethane foam includes a reaction product of:
(a) at least one isocyanate,
(b) at least one isocyanate-reactive component; and
(c) water.

4. The cover as claimed in claim 3 wherein the at least one isocyanate, the at least one isocyanate-reactive component and water are in the presence of at least one of blowing agents, surfactants, cross-linking agents, extending agents, pigments, flame retardants, catalysts and fillers.

5. The cover as claimed in claim 4 wherein the polyurethane foam has a free rise density of from about 5 lb/ft³ to about 25 lb/ft³, a reactive cream time of from about 10 seconds to about 120 seconds, and an elongation of from about 30% to about 300%.

6. The cover as claimed in claim 1 wherein the electronic device comprises:
(a) a substrate having a top surface and a bottom surface,
(b) an antenna coupled to at least one of the top and bottom surfaces of the substrate, and
(c) an integrated circuit (IC) chip module conductively coupled to the antenna.

7. The cover as claimed in claim 6 wherein the substrate is shaped to define an opening that extends from the top surface to the bottom surface.

8. The cover as claimed in claim 7 wherein the IC chip module comprises:
(a) a lead frame, and
(b) an IC chip conductively mounted on the lead frame.

9. The cover as claimed in claim 8 wherein the IC chip is at least partially encapsulated within an IC package.

10. The cover as claimed in claim 9 wherein the IC chip is coupled to the antenna such that the IC package at least partially projects into the opening defined in the substrate.

11. The cover as claimed in claim 1 wherein the layer of cover material is constructed of a material from the group consisting of cloth, synthetic cloth, cotton and composites thereof.

12. A method of manufacturing a cover for a passport, booklet or the like, the method comprising the steps of:
(a) providing an electronic device,
(b) providing a layer of cover material,
(c) applying a fill-up adhesive layer onto at least one of the electronic device and the layer of cover material,
(d) holding the layer of cover material and the electronic device apart from one another so as to define a void therebetween,
(e) expanding the fill-up adhesive layer to fill in the entire void between the electronic device and the layer of cover material, and
(f) curing the fill-up adhesive layer to bond the electronic device to the layer of cover material.

13. The method of claim 12 wherein the fill-up adhesive layer is in the form of a polyurethane foam.

14. The method of claim 13 wherein the polyurethane foam includes a reaction product of:
(a) at least one isocyanate,
(b) at least one isocyanate-reactive component; and
(c) water.

15. The method of claim 14 wherein the at least one isocyanate, the at least one isocyanate-reactive component and water are in the presence of at least one of blowing agents, surfactants, cross-linking agents, extending agents, pigments, flame retardants, catalysts and fillers.

16. The method of claim 15 wherein the polyurethane foam has a free rise density of from about 5 lb/ft³ to about 25 lb/ft³, a reactive cream time of from about 10 seconds to about 120 seconds, and an elongation of from about 30% to about 300%.

17. The method of claim 16 wherein the electronic device comprises:
(a) a substrate having a top surface and a bottom surface,
(b) an antenna coupled to at least one of the top and bottom surfaces of the substrate, and
(c) an integrated circuit (IC) chip module conductively coupled to the antenna.

18. The method of claim 17 wherein the layer of cover material is constructed of a material from the group consisting of cloth, synthetic cloth, cotton and composites thereof.

19. A cover for a passport, booklet or the like produced by the method of claim 12.

20. A cover for a passport, booklet or the like, the cover comprising:
(a) an electronic device having a top surface and a bottom surface, and
(b) a fill-up adhesive layer bonded directly onto one of the top and bottom surfaces of the electronic device, the fill-up adhesive layer having an exposed outer surface that is textured and colored to resemble a layer of cover material.
